(19) United States
(12) Patent Application Publication
(10) Pub. No.: US 2005/0243334 A1
(43) Pub. Date: Nov. 3, 2005

(54) Image processing method, image processing apparatus and image processing program

(75) Inventor: Chieko Sato, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA MEDICAL & GRAPHIC, INC.

(21) Appl. No.: 11/113,103

(22) Filed: Apr. 25, 2005

(30) Foreign Application Priority Data
Apr. 28, 2004 (JP) JP2004-133769

(51) Int. Cl. G06K 1/00

(52) U.S. Cl. 358/1.3

(57) ABSTRACT

There is described image-processing method and apparatus for applying an image processing to radiation image data, representing a radiation image acquired by projecting radial rays penetrated through a subject, so as to convert the radiation image to a processed radiation image suitable for a diagnosing purpose. The image-processing apparatus includes: an edge detecting section to detect an edge of a structural image contained in the radiation image; a geometrical shape measuring section to measure degree of a geometrical shape contoured by the edge detected by the edge detecting section; a weight determining section to determine a weight of the structural image, based on the degree of the geometrical shape measured by the geometrical shape measuring section; and an image-processing section to apply the image processing to the radiation image data, based on a parameter corresponding to the weight determined by the weight determining section.

This application is based on Japanese Patent Application NO. 2004-133769 filed on Apr. 28, 2004 in Japanese Patent Office, the entire content of which is hereby incorporated by reference.

### BACKGROUND OF THE INVENTION

The present invention relates to an image processing method, image processing apparatus and image processing program for processing a radiation image, particularly to an image processing method, image processing apparatus and image processing program for providing a radiation image suitable for a diagnosing purpose.

An apparatus capable of capturing a radiation image directly as a-digital image has been developed in recent years. For example, the Official Gazette of Japanese Patent Tokkaisho 55-12429, the Official Gazette of Japanese Patent Tokkaisho 63-189853 and others disclose the apparatuses for detecting the amount of radial rays applied to a subject and acquiring the radiation image formed in conformity to the detected amount, in the form of an electrical signal, according to the method based on a detector using a stimulable phosphor.

In the aforementioned apparatuses, the radial ray having passed through a subject is applied to a detector with a stimulable phosphor stuck onto a sheet-like substrate by coating or vapor deposition, and the radial ray is absorbed by stimulable phosphor.

After that, the stimulable phosphor is excited by light or thermal energy, whereby radiation energy accumulated through the aforementioned absorption of the stimulable phosphor is reflected as fluorescent light. This fluorescent light is subjected to photoelectric conversion, thereby getting an image signal.

Another proposal is a radiation image detection apparatus wherein an electric charge in conformity to the strength of the radial ray applied is generated on the photoconductive layer, and the generated electrical charge is accumulated in a plurality of capacitors arranged in a two-dimensional array. Then the accumulated electrical charge is taken out.

The aforementioned radiation image detection apparatus uses what is called a flat panel detector (FPD). As disclosed in the Official Gazette of Japanese Patent Tokkaihei 9-90048, this FPD is implemented by a combination of:
a phosphor for emitting the fluorescent light in conformity to the strength of the applied radial ray, and
a photoelectric conversion device such as a photo diode or a CCD that receives the fluorescent light emitted from the phosphor to perform photoelectric conversion directly or through a reduced optical system.

In the apparatus disclosed in the Official Gazette of Japanese Patent Tokkaihei 6-342098, the applied radiation is directly converted into electrical charge.

In the aforementioned radiation image detection apparatuses, the common practice is to apply image processing such as gradient conversion processing or edge enhancement processing to the acquired image so as to get an image suitable for a diagnostic purpose. When displaying or outputting the radiation image-based on the image data obtained in this manner, image processing is applied so as to provide an easy-to-see radiation image, independently of the fluctuation of the radiographing conditions.

Conventionally, gradient processing has been applied subsequent to deterministic recognition of a structural human body required to determine the gradient, or preliminary deterministic recognition of an unwanted structural human body and elimination thereof.

Further, frequency processing dependent on the frequency band, density and contrast of the structure has been applied.

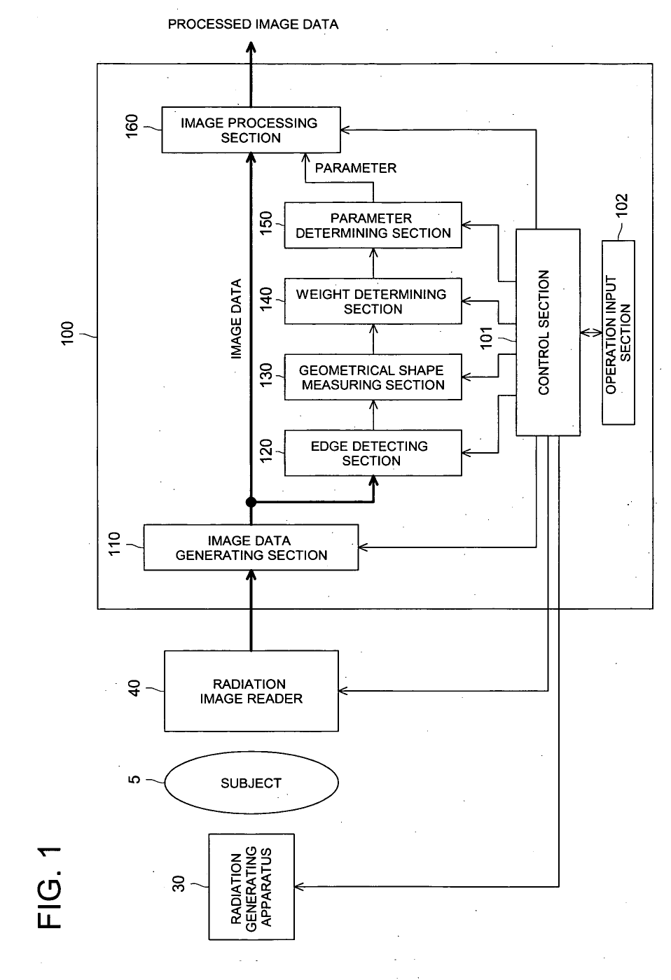

Thus, the method for image processing subsequent to deterministic recognition of a structural radiation image is disclosed in the following Patent Documents 1 and 2:
[Patent Document 1] Official Gazette of Japanese Patent Tokkai 2002-183726 (page 1 and FIG. 1)
[Patent Document 2] Official Gazette of Japanese Patent Tokkai 2002-183727 (pages 1 through 5 and FIG. 1)

In the conventional method, insufficient or excessive elimination has occurred in the event of failure to recognize a structural human body or a structural non-human body or the unclear boundary of the structural non-human body. Insufficient or excessive elimination has, in turn, caused a big fluctuation in the result of gradient processing. In addition to this problem, frequency processing dependent on the frequency band, density and contrast is applied without distinction between the structural human body and structural non-human body. This has resulted in a failure to sufficiently restrict the unwanted enhancement of the end of the irradiation field of the structural non-human body.

### SUMMARY OF THE INVENTION

To overcome the abovementioned drawbacks in conventional image-processing apparatus, it is an object of the present invention to provide an image-processing method, an image-processing apparatus and an image-processing program, each of which makes it possible to reduce the bad influences, occurring when a recognizing operation of a structure in the image is failed or boundaries of the structure are not clear, so as to conduct the image-processing operation based on appropriate image-processing conditions.

Accordingly, to overcome the cited shortcomings, the abovementioned object of the present invention can be attained by image-processing methods, image-processing apparatus and an image-processing program described as follow.

(1) An image-processing method for applying an image processing to radiation image data, representing a radiation image acquired by projecting radial rays penetrated through a subject, so as to convert the radiation image to a processed radiation image suitable for a diagnosing purpose, the image-processing method comprising the steps of: detecting an edge of a structural image contained in the radiation image; measuring degree of a geometrical shape contoured by the edge detected in the detecting step; determining a weight of the structural image, based on the degree of the geometrical shape measured in the measuring step; and applying the image processing to the radiation image data, based on a parameter corresponding to the weight determined in the determining step.

(2) The image-processing method of item 1, wherein at least one of a gradient processing and a frequency processing is applied in the applying step.

(3) The image-processing method of item 1, wherein the geometrical shape includes a straight line or a circle determined in advance as a measuring object, and, with respect to the straight line or the circle, the degree of the geometrical shape contoured by the edge is measured in the measuring step.

(4) The image-processing method of item 1, wherein a Hough Transform is employed for measuring the degree of the geometrical shape contoured by the edge in the measuring step, and, based on a vote number acquired by applying the Hough Transform to a measuring object, the degree of the geometrical shape is measured in the measuring step.

(5) The image-processing method of item 1, wherein a filter processing is applied to the radiation image data in the detecting step to detect the edge of the structural image contained in the radiation image; and wherein the filter processing includes at least one of a Laplacian filtering operation, a differential filtering operation, a multi-resolution analyzing operation, a Wavelet transforming operation and a three-channel filter bank operation.

(6) The image-processing method of item 5, wherein a Sobel filtering operation is employed as the differential filtering operation to detect the edge of the structural image contained in the radiation image.

(7) The image-processing method of item 5, wherein a combination of a simple average filter, a Laplacian filter and a Sobel filter is employed for the three-channel filter bank operation in the detecting step.

(8) The image-processing method of item 1, wherein the greater the degree of the geometrical shape, measured in the measuring step with respect to a processing object, is, the more the weight to be determined is increased.

(9) The image-processing method of item 1, wherein the greater the degree of the geometrical shape, measured in the measuring step with respect to a processing-excluded object, is, the more the weight to be determined is decreased.

(10) The image-processing method of item 1, wherein the weight is determined for every pixel, included in the radiation image data, in the determining step.

(11) The image-processing method of item 1, wherein, based on a function determined in advance, the weight is determined in the determining step.

(12) The image-processing method of item 11, wherein a primary combined function combined with an edge strength is employed as the function in the determining step.

(13) The image-processing method of item 1, wherein the weight is determined in the determining step, based on relationship between a plurality of degrees of geometrical shapes, each corresponding to the degree of the geometrical shape, measured by the geometrical shape measuring section.

(14) The image-processing method of item 13, wherein, when the plurality of degrees of geometrical shapes indicate straight lines, the relationship between the plurality of degrees of geometrical shapes is determined, based on a fact that the straight lines, having substantially a same degree of geometrical shape, reside at constant intervals.

(15) An image-processing apparatus for applying an image processing to radiation image data, representing a radiation image acquired by projecting radial rays penetrated through a subject, so as to convert the radiation image to a processed radiation image suitable for a diagnosing purpose, the image-processing apparatus comprising: an edge detecting section to detect an edge of a structural image contained in the radiation image; a geometrical shape measuring section to measure degree of a geometrical shape contoured by the edge detected by the edge detecting section; a weight determining section to determine a weight of the structural image, based on the degree of the geometrical shape measured by the geometrical shape measuring section; and an image-processing section to apply the image processing to the radiation image data, based on a parameter corresponding to the weight determined by the weight determining section.

(16) The image-processing apparatus of item 15, wherein the image-processing section includes at least one of a gradient processing section for applying a gradient processing and a frequency processing section for applying a frequency processing.

(17) The image-processing apparatus of item 15, wherein the geometrical shape includes a straight line or a circle determined in advance as a measuring object, and the geometrical shape measuring section measures the degree of the geometrical shape contoured by the edge with respect to the straight line or the circle.

(18) The image-processing apparatus of item 15, wherein the geometrical shape measuring section employs a Hough Transform to measure the degree of the geometrical shape contoured by the edge, and measures the degree of the geometrical shape, based on a vote number acquired by applying the Hough Transform to a measuring object.

(19) The image-processing apparatus of item 15, wherein the edge detecting section applies a filter processing to the radiation image data to detect the edge of the structural image contained in the radiation image; and wherein the filter processing includes at least one of a Laplacian filtering operation, a differential filtering operation, a multi-resolution analyzing operation, a Wavelet transforming operation and a three-channel filter bank operation.

(20) The image-processing apparatus of item 19, wherein the edge detecting section employs a Sobel filtering operation as the differential filtering operation to detect the edge of the structural image contained in the radiation image.

(21) The image-processing apparatus of item 19, wherein the edge detecting section employs a combination of a simple average filter, a Laplacian filter and a Sobel filter for the three-channel filter bank operation.

(22) The image-processing apparatus of item 15, wherein the greater the degree of the geometrical shape, which is measured by the geometrical shape measuring section with respect to a processing object, is, the more the weight determining section increases the weight to be determined.

(23) The image-processing apparatus of item 15, wherein the greater the degree of the geometrical shape, which is measured by the geometrical shape measuring section with respect to a processing-excluded object, is, the more the weight determining section decreases the weight to be determined.

(24) The image-processing apparatus of item 15, wherein the weight determining section determines the weight for every pixel included in the radiation image data.

(25) The image-processing apparatus of item 15, wherein the weight determining section determines the weight, based on a function determined in advance.

(26) The image-processing apparatus of item 25, wherein the weight determining section employs a primary combined function combined with an edge strength as the function.

(27) The image-processing apparatus of item 15, wherein the weight determining section determines the weight, based on relationship between a plurality of degrees of geometrical shapes, each corresponding to the degree of the geometrical shape, measured by the geometrical shape measuring section.

(28) The image-processing apparatus of item 27, wherein, when the plurality of degrees of geometrical shapes indicate straight lines, the relationship between them is determined, based on a fact that the straight lines, having substantially a same degree of geometrical shape, reside at constant intervals.

(29) A program for executing an image-processing operation for applying an image processing to radiation image data, representing a radiation image acquired by projecting radial rays penetrated through a subject, so as to convert the radiation image to a processed radiation image suitable for a diagnosing purpose, the program comprising the functional steps of: detecting an edge of a structural image contained in the radiation image; measuring degree of a geometrical shape contoured by the edge detected in the detecting step; determining a weight of the structural image, based on the degree of the geometrical shape measured in the measuring step; and applying the image processing to the radiation image data, based on a parameter corresponding to the weight determined in the determining step; wherein at least one of a gradient processing and a frequency-processing is applied in the applying step.

According to the present invention, the following effects can be attained.

1). The edge of the structural image is detected, and a degree of a geometrical shape contoured by the detected edge is measured. Based on the detected degree of a geometrical shape, the weight of the structural image is determined, and image processing is applied according to the parameter corresponding to the weight determined.

To put it another way, the weight is determined with respect to the geometrical shape contoured by the edge of the structural image, and image processing is applied. This method is not affected by the recognition failure resulting from deterministic recognition or recognition failure of unclear boundary. This procedure ensures recognition of a structural image and determination of the weight free from the possibility of recognition failure. Thus, adequate image processing can be applied without recognition failure, despite the presence of an unclear boundary.

2). Image processing includes at least one of gradient processing and frequency processing.

The present invention ensures recognition of a structural image and determination of a weight without recognition failure. This method enables adequate gradient processing by minimizing the adverse impact in the event of recognition failure or unclear boundary, and reduces unwanted enhancement of the structural non-human body resulting from frequency processing.

3). In the measurement of geometrical shape, a straight line or a circle is determined in advance as an object to be measured, and the degree of a geometrical shape is measured with respect to the straight line of the circle.

This method allows the weight to be determined with respect to the straight line and/or the circle, and hence ensures adequate recognition in the irradiation field or metal edge often characterized by a rectangular or circular form.

The structural non-human body as a structural image refers to an artificial bone or the end of irradiation field. Here a circle or a straight line is determined as a geometrical shape, whereby a structural non-human body (artificial bone or the end of irradiation field) as a structural image is recognized. Thus, adequate gradient processing and frequency processing can be applied even if the boundary is blurred, without being affected by recognition failure of a structure of less importance or an unwanted structure in the image.

4). A Hough Transform is employed to measure the aforementioned degree of the geometrical shape contoured by the edge. Further, the degree of the geometrical shape contoured by the edge is measured based on a vote number acquired by applying the Hough Transform to an object to be measured.

The geometrical shape data obtained by measuring the geometrical shape represents the vote number of a predetermined graphic obtained by the Hough Transform. Thus, adequate geometrical shape can be recognized without deterministic recognition, even when the boundary is less defined.

5). The edge of a structural image is detected by filter processing including at least one of the Laplacian filtering operation, differential filtering operation, multi-resolution analyzing operation, Wavelet transforming operation and three-channel filter bank operation.

To be more specific, application of the aforementioned filter processing provides a faithful response to a slope in an affected area, and hence effective edge detection. Thus, from the effectively detected edge of the structural image, a weight is determined with respect to geometrical shape. This method is not affected by the conventional recognition failure resulting from deterministic recognition or recognition failure of an unclear boundary. This procedure ensures recognition of a structural image and determination of the weight free from the possibility of recognition failure. Thus, adequate image processing can be applied without recognition failure, despite the presence of an unclear boundary.

6). A Sobel filtering processing is employed to detect the edge of a structural image by the differential filtering operation.

To be more specific, use of this Sobel filter processing as a differential filtering operation enhances the degree of response to the slope in the affected area, and provides effective edge detection. Based on the edge of the structural image having been detected effectively, a weight is determined with respect to geometrical shape, and image processing is applied. This method is not affected by the recognition failure resulting from deterministic recognition or recognition failure of an unclear boundary. Accordingly, this procedure ensures recognition of a structural image and determination of the weight free from the possibility of recognition failure. Thus, adequate image processing can be applied without recognition failure, despite the presence of an unclear boundary.

7). The edge of a structural image is detected by a three-channel filter bank operation as a combination of a simple average filter processing and a Laplacian filter processing.

Use of the three-channel filter bank operation provides more effective edge detection. Thus, from the effectively detected edge of the structural image, a weight is determined with respect to geometrical shape, and image processing is carried out. This method is not affected by the recognition failure resulting from deterministic recognition or recognition failure of an unclear boundary. This procedure ensures recognition of a structural image and determination of the weight free from the possibility of recognition failure. Thus, adequate image processing can be applied without recognition failure, despite the presence of an unclear boundary.

8). When the degree of geometrical shape having been measured is related to an object to be processed, the weight to be determined is increased as the degree of geometrical shape is greater.

As described above, the weight is increased as the degree of geometrical shape is greater. When the degree of geometrical shape having been measured is related to an object to be processed, this configuration avoids the possibility of recognition failure resulting from deterministic recognition, and permits adequate recognition of a geometrical shape, despite the presence of an unclear boundary.

9). When the degree of geometrical shape having been measured is related to an object not to be processed, the weight to be determined is decreased as the degree of geometrical shape is greater.

As described above, the weight is decreased as the degree of geometrical shape is greater. When the degree of geometrical shape having been measured is related to an object not to be processed, this configuration avoids the possibility of recognition failure resulting from deterministic recognition, and permits elimination of a structure of less importance such as a structural non-human body.

The weight is determined by the degree of a geometrical shape. This arrangement ensures more accurate distinction between an object to be processed and an object not to be processed.

When the geometrical shape having been measured is a straight line, the distance of a straight line of the same degree of geometrical shape provides more accurate recognition of an object to be processed and an object not to be processed.

10). The weight is determined for each pixel of the radiation image. This arrangement provides more detailed assignment of weight. For example, this arrangement allows the degree of enhancement in frequency processing to be reduced for each of the pixels less heavily weighted. A smaller degree of enhancement can be selectively assigned to noise or an unwanted area such as the area outside the irradiation field.

11). The weight is determined based on a function determined in advance. This arrangement ensures adequate gradient processing and frequency processing.

12). A primary combined function with edge strength is used as the function for determining the weight. This primary combined function permits weighting with consideration given to the clarity of an edge, thereby ensuring more adequate gradient processing and frequency processing.

Since the weight is determined by the Gaussian function having a degree of geometrical shape as a parameter, flexible recognition of a structure is enabled even if the edge is not sharp.

13). The edge of the structural image of a radiation image is detected and the degree of the geometrical shape contoured by the detected edge is measured. Based on the measured degree of the geometrical shape, the weight of the structural image is determined, and image processing is applied by the parameter conforming to the weight determined in this manner.

To be more specific, the weight is determined with respect to the geometrical shape contoured by the edge of the structural image, whereby image processing is applied. This procedure is not affected by the recognition failure resulting from deterministic recognition or recognition failure of an unclear boundary. This procedure ensures recognition of a structural image and determination of the weight free from the possibility of recognition failure. Thus, adequate image processing can be applied without recognition failure, despite the presence of an unclear boundary.

### BRIEF DESCRIPTION OF THE DRWINGS

Other objects and advantages of the present invention will become apparent upon reading the following detailed description and upon reference to the drawings in which:

FIG. 1 shows a functional block diagram, which functionally represents an overall configuration of an exemplified embodiment embodied in the present invention;

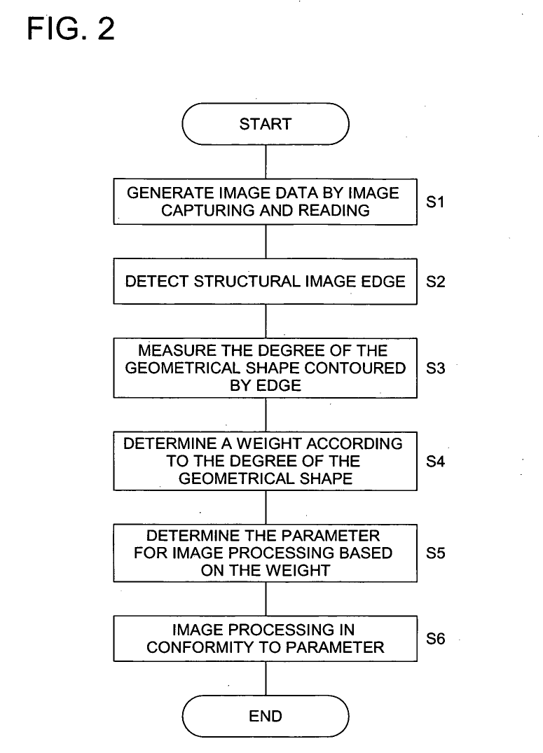

FIG. 2 shows a flowchart of overall processing performed in an exemplified embodiment embodied in the present invention;

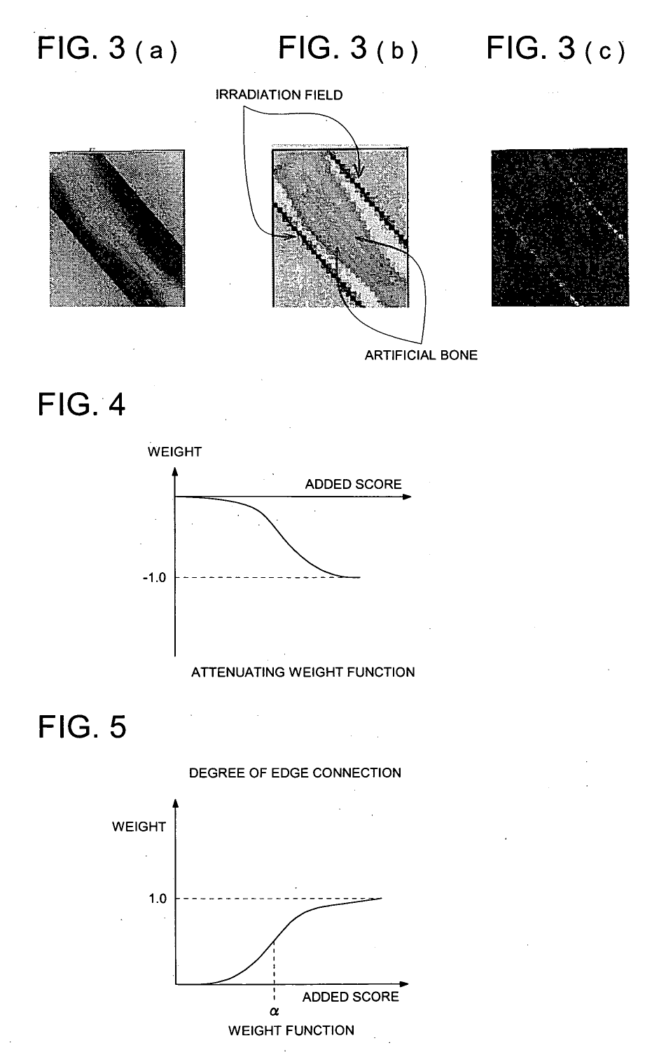

FIG. 3(a), FIG. 3(b) and FIG. 3(c) show explanatory drawings for explaining an image-processing operation embodied in the present invention;

FIG. 4 shows a graph for explaining an image-processing operation embodied in the present invention;

FIG. 5 shows a graph for explaining an image-processing operation embodied in the present invention;

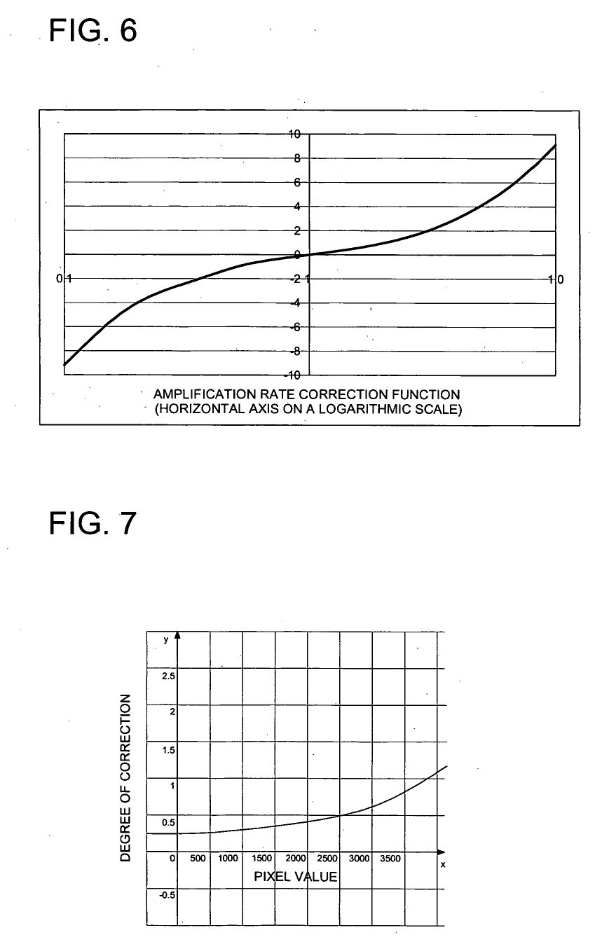

FIG. 6 shows a graph for explaining an image-processing operation embodied in the present invention;

FIG. 7 shows a graph for explaining an image-processing operation embodied in the present invention;

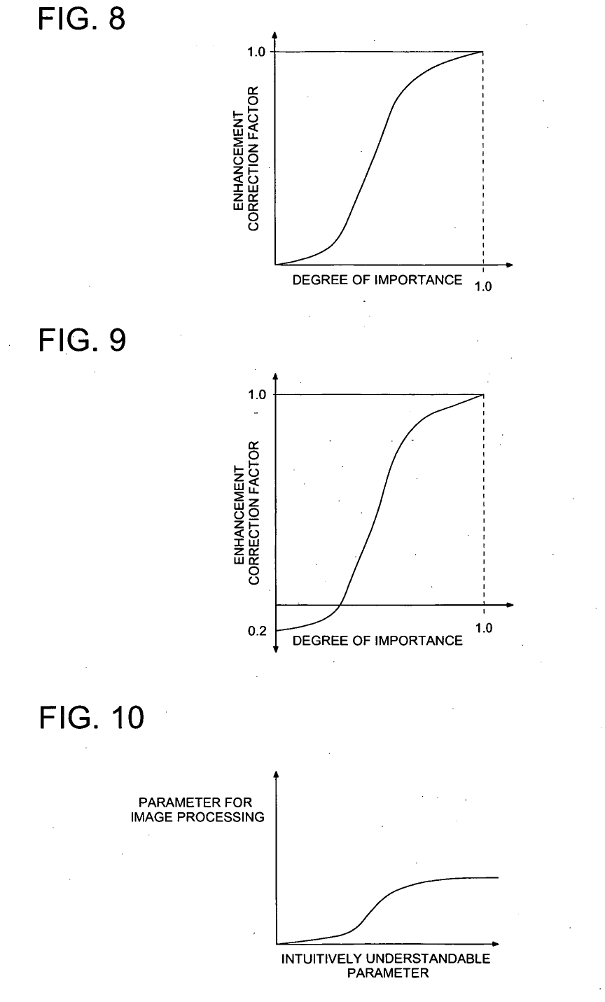

FIG. 8 shows a graph for explaining an image-processing operation embodied in the present invention;

FIG. 9 shows a graph for explaining an image-processing operation embodied in the present invention;

FIG. 10 shows a graph for explaining an image-processing operation embodied in the present invention; and

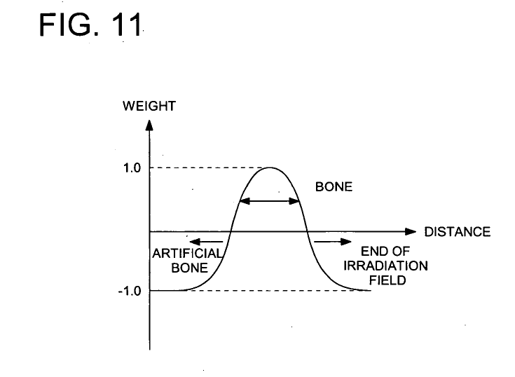

FIG. 11 shows a graph for explaining an image-processing operation embodied in the present invention.

### DETAILED DESCRIPTION OF THE PREFERRED EMBODIMENT

Referring to the drawings, the following provides a detailed description of the best form of embodiment of the present invention, and demonstrates the preferred embodiments of the image processing method, image processing apparatus and image processing program for ensuring the best form of the present invention to be implemented, without the present invention being restricted thereto.

The means used in various embodiments of the present invention can be composed of hardware, firmware or software. FIG. 1 is a functional block diagram representing each step in the image processing method, each means of the image processing apparatus and each routine of the image processing program given according to the arrangement of processing.

The following describes the configuration and operation of the embodiments in the present invention, with reference to block diagram in FIG. 1, flowchart in FIG. 2 and other drawings for explanation: It should be noted that various sections in FIG. 1 indicate each means in the image forming apparatus, as well as each step in image processing method and each routine in image processing program.

<Overall Configuration and Processing Flow>

(a) Overall Configuration

A radiation generating apparatus 30, a radiation image reader 40 and an image processing apparatus 100 are configured as shown in FIG. 1.

As shown in FIG. 1, the image processing apparatus 100 comprises:
a control section 101 for controlling various sections;
an operation input section 102 for inputting the operation;
an image data generating section 110 for generating image data;
an edge detecting section 120 as an edge detecting means for detecting the edge of a structural image;
a geometrical shape measuring section 130 as a geometrical shape measuring means for measuring the degree of the geometrical shape contoured by the edge;
a weight determining section 140 as a weight determining means for determining the weight of a structural image, based on the degree of the geometrical shape having been measured;
a parameter determining section 150 as a parameter determining means for determining the parameter in conformity to the weight having been determined; and
an image processing section 160 as an image processing means for processing an image according to the parameter having been determined.
   (b) Flow of Processing:
The control section 101 controls various processing operations involved in radiographing and reading of a radiation image, image data generation, edge detection, measurement of a geometrical shape, determination of a weight and determination of an image processing parameter.
The radial rays from the radiation generating apparatus 30 pass through a subject 5. The radial rays having passed through the subject 5 are read by the radiation image reader 40.
The signal read by the radiation image reader 40 is converted into the image data representing a radiation image by the image data generating section 110 (S1 in FIG. 2).
The edge detecting section 120 detects the edge of the structural image of the radiation image (S2 in FIG. 2).
The geometrical shape measuring section 130 measures the degree of the geometrical shape contoured by the detected edge (S3 in FIG. 2).
Based on the degree of the geometrical shape having been measured, the weight determining section 140 determines the weight of the structural image (S4 in FIG. 2).
Based on the weight determined with respect to the structural image, the parameter determining section 150 determines the image processing parameter (image processing condition) (S5 in FIG. 2).
According to the parameter determined by the parameter determining section 150, the image processing section 160 applies image processing to the image data from the image data generating section 110 (S6 in FIG. 2).
   (Details of Means and Steps)
   (1) Operation and Control of Each Section

In the first place, the control section 101 acquires the information on the site or direction of image capturing, from the user interface or others. The user specifying the site to be captured inputs this information. For example, the information is inputted when the user presses the button indicating the site to be captured, from the operation input section 102 as a user interface of the image processing apparatus equipped with the functions of both a display section and a touch panel. Further, a magnetic card barcode or HIS (Hospital Information System: an information management system by network) can also be used to input the information.

(2) Inputting the Radial Ray

The radiation generating apparatus 30 is controlled by the control section 101. Having passed through the subject 5, the radial rays emitted from the radiation generating apparatus 30 are applied to the an image capturing panel arranged in front of the radiation image reader 40. The radiation image reader 40 detects the radial rays having passed through the subject 5, and acquires them as image signals.

Specific examples of the configuration using a stimulable phosphor plate can be found in the Official Gazette of Japanese Patent Tokkaihei 11-142998 and Official Gazette of Japanese Patent Tokkai 2002-156716. Further, the example of using a flat panel detector (FPD) as an input apparatus is disclosed in the Official Gazette of Japanese Patent Tokkaihei 6-342098, wherein the detected X-rays are converted directly into the electrical charge and are taken out as image signals. Another example is disclosed in the Official Gazette of Japanese Patent Tokkaihei 9-90048, wherein the detected X-rays are converted into light, which is then received and converted into the electrical charge indirectly.

Further, it is possible to arrange such a configuration that the radiation image reader 40 allows the light from such a light source as a laser and fluorescent lamp to be applied to the silver halide film with an radiation image recorded thereon; then the transmitted light of the silver halide is subjected to photoelectric conversion, whereby the image data is generated. It is also possible to arrange such a configuration that a radiation quantum counter type detector is used to convert the radiation energy directly into the electrical signal.

When the radiation image of the subject 5 is acquired, the subject 5 is located between the radiation generating apparatus 30 and the image capturing panel of the radiation image reader 40, and the radial rays emitted from the radiation generating apparatus 30 are applied to the subject 5. At the same time, the radial rays having passed through the subject 5 are launched into the image capturing panel.

(3) Edge Detection

Here the geometrical shape measuring section 130 detects the edge of the structural image of a radiation image. A differential filter can be used to detect the edge. The differential filter includes a Sobel filter, a Prewitt filter and a Roberts filter. They are each helpful in detecting the edge.

To detect the edge, it is also possible to utilize the multiple resolution of such a filter as a Wavelet filter, Gaussian and Laplacian filters, in addition to the aforementioned filters.

The details are described in ARAI Kohei, “Basic Theory on Wavelet Analysis”, Morikita Publishing Co., Ltd., 2000, P. 80.

It is well known in the art that these filters are effective in detecting an edge. For example, when the Laplacian filter is used, the portion having a density slope can be extracted. Especially, it allows extraction of the end of irradiation field, artificial bone and others where there is a big difference in slope. The differential filter provides the same advantage. It allows the direction of an edge to be taken into account. Further, more effective edge detection is ensured by a combination of these edge detecting methods. In such a combination, edge detection must be performed independently.

Thus, more effective edge extraction is provided by a three-channel filter bank. The three-channel filter bank provides a filter processing means for applying the process of filtering to the digital data. This filter is configured in a three-channel filter bank form, and includes:
a decomposition filter section for separation the digital data using a plurality of filters of different characteristics;
a down-sampling section for down-sampling each of the decomposition and outputting functions of the separation filter; and
a re-composition filter section for re-integrating the separated digital data in response to the output of the down-sampling section. The separation filter section refers to the section comprising a Laplacian filter and a differential (Sobel) filter and an averaging filter.

The edge can be detected by applying the following processing to the signal obtained by the process of filtering and others as described above:

(3a) Multi-Scale Edge

All edge components including filter type, resolution and direction are added. This procedure allows the edge image to be created with due consideration given to all such factors as the scale, direction and edge type.

(3b) Minimum Edge

The minimum edge in each pixel corresponding to each resolution is assumed as the value for edge pixel. This arrangement allows the most reliable value (at least an edge of this value or thereabout can be assumed to be present) to be set.

(3c) Maximum Edge

The maximum edge in each pixel corresponding to each resolution is assumed as the value for edge pixel. This arrangement allows setting of the maximum value that can be present as an edge.

(3d) Linear Increasing/Decreasing Edge

An edge is extracted wherein an almost “0” value is assumed in the processing by the Laplacian filter, and a value other than “0” is assumed in the processing by the Sobel filter. Extraction of the edge in this manner allows extraction of only the area that exhibits a linear increment or decrement.

Use of the three-channel filter bank operation as described above permits simultaneous execution of three types of filter processing, and facilitates use of an edge by a combination thereof.

(4) Measuring the Geometrical Shape

The geometrical shape measuring section 130 measures the degree of the geometrical shape with respect to the edge detected by the edge detecting section 130.

The following describes an example of detecting the linearity using a multi-scale edge. FIG. 3(a) shows a radiation image as a basic figure. FIG. 3(b) represents the multi-scale edge image obtained by detecting the edge through filter processing of the radiation image.

As can be seen from FIG. 3(b), except for the edge of the subject (lower extremity) important for diagnosis, the edge on the end of irradiation field and edge of an artificial bone are also detected.

However, the edges of the structural non-human body including the end of the irradiation field or artificial bone has a high degree of linearity and circularity. Thus, the edge having a high degree of linearity and circularity is detected, and a higher weight is assigned to a higher degree of linearity and circularity, for example, whereby a structural non-human body can be recognized. If a lower weight is assigned thereto, the edge of the structural non-human body is attenuated and the unwanted edge can be minimized.

Hough Transform is applied to a multi-scale edge image for conversion into a parameter space. For example, the Hough Transform is applied to a 12-bit gradient image so that the 50% edges or more between the maximum and minimum values of the edge are converted into the parameter space. Use of the value 50% in this case makes it possible to extract largely the edge of the end of the irradiation field or artificial bone that may adversely affect gradient processing or frequency processing, wherein the human edge important for image processing are not extracted.

The Inverse Hough Transform can be used to obtain the straight line where the vote number in this parameter space is equal to or greater than a certain value. The details are given in MORI Shunji and ITAKURA Kumiko, “Basics of Image Recognition II—Extraction of features, Edge Detection and Texture Analysis”, Ohm Publishing Co., Ltd., 1990.

The vote number in the parameter space denotes the connectivity of the straight line and circle. This connectivity is preferably adjustable according to the image. When this connectivity is detected based on the image obtained by sub-sampling the actually acquired image at a sampling pitch of 1.4 mm, the threshold value of the connectivity of the straight line is preferably set to about 50, in the case of the bones of the lower leg where the cassette size to be radiographed is as large as a 14×17-inch size. It is preferably set to about 20, in the case of a newborn baby where the cassette size to be radiographed is as small as an 8×10-inch size. Further, when a circular irradiation field of an temporal bone and others is used, an 8×10-inch sized cassette is often used. In this case, the connectivity is preferably about 30. There are a plurality of straight lines and circles to be detected in this case, and there is a point where a plurality of straight lines pass. This is because the actual edge portion is gently sloping to some extent. Since this slope is not always constant, the conventional technique of eliminating that portion has resulted in recognition error or incomplete elimination.

(5) Determining the Weight

The weight determining section 140 determines the weight of the structural image based on the degree of the geometrical shape having been measured.

The aforementioned connectivity can be used as a score for determining the weight. Here detailed explanation will be given to the case where the score is added every time the straight line passes through each pixel, thereby determining the weight of the degree of participation relation of the pixel to the straight line.

This weight represents the degree of commitment to the straight line with consideration given to the edge slope. In this case, when an attenuating weight is assigned, the weight of the structural non-human body can be reduced with consideration given to the status of the slope. Further, the weight can be determined by the function having the added score as a parameter.

FIG. 4 shows the attenuating weight function. A sudden decrease in weight is caused by the increase in the added score resulting from connection. In FIG. 4, the weight is −1.0 when the added score resulting from connection is the same as the number of the pixels in the longitudinal direction of the image.

Further, the edge strength can be taken into account by applying the edge strength to this weight. Here the edge strength is defined as the result of the multi-scale edge.

If the primary combined function (linear combined function) is used as a function for determining the weight, it is possible to determine weight conforming to the edge strength as well as the degree of commitment to the straight line. For example, when the edge of the end of the irradiation field is to be attenuated, impact on the image processing is greater when the edge strength is higher. When the weight is determined in this manner, the weight can be reduced in conformity to the edge strength.

It should be noted that the weight can be determined by the primary combined function with the conditions other than the edge strength.

Further, as shown in FIG. 5, the commitment to the straight line is greater in particular, as the added number is greater. Thus, it is also possible to achieve a sudden increase in the weight with the increase in the added score. In this case, if the aforementioned threshold value of the edge detection is kept at a value not exceeding 50%, the edge of a structural human body can be extracted, contrary to the aforementioned example. For example, in the case of the bones of the lower leg, this can be used to extract the bone.

In FIG. 5, the weight is 1.0 when the added score resulting from connection is the same as the number of the pixels in the longitudinal direction of the image. α indicates an example of the added score resulting from the connection that has been detected.

Further, the degree of the geometrical shape, for example, the degree of straight line can be used for each pixel. FIG. 3(c) shows the image wherein the weight is determined according to the attenuating weight determining method. In FIG. 3(c), the weight is greater when the degree of blackness for each pixel is higher, while the weight is smaller when the degree of whiteness for each pixel is higher. This indicates that the weight of the end of irradiation field is smaller.

The Hough Transform allows a circle to be detected in the same manner. This technique is also applicable to the circular irradiation field that is used for the image of a human head. The Hough Transform is also applicable to detection of any desired graphic data. Thus, the edge of a protector and others can be detected by setting a parameter space.

As shown in FIG. 11, the weight can also be determined by the degree of the geometrical shape. In the case of the lower leg, for example, the metals or related substances having a high degree of linearity as objects not to be processed are located inside the bone, and are detected as two straight lines, almost parallel to each other, located close to each other. The edge of the irradiation field is positioned outside the human body as an object to be processed, and are therefore detected as two straight lines, almost parallel to each other, located close to each other. By contrast, the bone as an object to be processed is recognized as two straight lines, almost parallel to each other, located at a distance intermediate between them. Thus, a weight is assigned using the weight function having as a parameter the distance shown in FIG. 11, by addition or multiplication of the weight of linear form. This arrangement permits more accurate recognition of an object to be recognized or an object not to be recognized.

In the radiation image, the edge exhibits a sharper slope than other site, but has a small quantity of width. To give a flexible decision that this small quantity of width is a geometrical structure, a weight is assigned using the Gaussian function, centering on the pixel included in the shape recognized by the Hough Transform, for example. In this case, the peak of the Gaussian function is determined by the degree of the geometrical shape. This permits flexible recognition of a structure.

As described above, a weight is determined according to the degree of the geometrical shape. This method ensures recognition of a structure, without being affected by the recognition failure resulting from deterministic recognition or recognition failure of unclear boundary.

Further, use of the weight in the aforementioned manner enables adequate gradient processing and frequency processing. In gradient processing, for example, the weight assignment of the present invention is applied to a sub-sampled image. Gradient processing is applied according to the weight, whereby adequate processing is carried out, without being affected by the edge on the end of the irradiation field or edge of the artificial bone. Further, if the weight assignment of the present invention is applied to an original image, it is possible to avoid unwanted enhancement of the edge on the end of the irradiation field or edge of the artificial bone.

(6) Parameter Determination and Image Processing

Here the parameter determining section 150 determines the image processing parameter (image processing conditions), based on the weight determined with respect to the structural image. The image processing section 160 processes the image data from the image data generating section 110, according to the parameter determined by the parameter determining section 150. In this case, at least one of gradient processing and frequency processing is carried out as image processing.

The following describes the method of determining the parameter determining section 150:

(6-1) Gradient Processing

When the weight has been determined as described above, it is used to determine the gradient processing conditions using the following evaluation function.

In the gradient processing, the gradient processing conditions are determined using the following function:

The feature quantity estimator function as a LUT shift value S and rotational value G are set as follows:

[Eq. 1]

Assume that L(s, g) (xij) is the result of converting the image xij according to the LUT using slide value “s” and rotational value “g”. Also assume that Δ is a very small constant. In this case, signal amplification rate A (Δ, s, g) (xij) of “s” and “g” with respect to the pixel xij is expressed by:

$$A ( Δ , s , g ) ( Xij ) = \vert \frac{L ( s , g ) ( xij - Δ ) - L ( s , g ) ( xij + Δ )}{2 Δ} \vert$$

Here the characteristic quantity evaluation function of “s” and “g” with respect to image I is given by:

$$EI ( s , g ) = {\sum }_{xij ∈ I} \{ f ( A ( Δ , s , g ) ( xij ) \times W ( i , j ) \}$$

where f(x) denotes a function for correcting the signal amplification rate, and W(i, j) and xij indicates the weight.

To put it more specifically:
f(x)=x−1 where x≧1;
f(x)=−(1/x−1) where 1>x>−1; and
f(x)=−C where x=0.

Here “C” denotes amplification rate when the signal is converted to “0”. By applying such a correction function (amplification rate correction function shown in FIG. 6), a higher or lower amplification rate can be added or subtracted for evaluation on a priority basis. Values s and g are determined in such a way that EI (s, g)-will be the maximum.

FIG. 6 shows an example of the characteristics of the amplification rate correction function. The signal amplification rate is plotted on the horizontal axis, while the score subsequent to correction is plotted in a logarithmic scale on the vertical axis. The amplification rate is plotted on the vertical axis.

This arrangement allows the pixel image having a greater weight in the image to be converted most effectively according to the LUT so as to be amplified. It is preferred that Δ in the aforementioned equation should be in the order of 3 through 5.

(6-2) Frequency Processing

Here frequency processing includes the following equalization processing and frequency processing:

(6-2-1) Equalization Processing

Equalization processing is to keep all areas in an image within the visible range, by compressing the dynamic range of the image. In equalization processing, the contrast of the overall image tends to deteriorate if the processing is applied excessively. It is preferred that the dynamic range should be compressed adequately.

For adequate compression of the dynamic range, a weighted histogram H(x) is generated in the first place, where x denotes a variable assuming a value within the dynamic range of an image. In the case of a 12-bit image, 4095≧x≧0. H(x) is defined as follows:

$$H ( x ) = {\sum }_{xij = x} xij \times W ( i , j ) \times D ( x ) \qquad [ Eq . 2 ]$$

where Σ takes a sum only when the overall image is scanned and the pixel value is.

In this equation, the D(x) denotes a weighted histogram correction function. If arrangements are so made as shown in FIG. 7, adjustment can be made in such a way that the weight of the high signal value alone is increased in the equalization processing. This is effective when emphasis is placed on rendering of the skin or the like.

When the aforementioned H(x) is taken into account, evaluation can be made with both the weight and the number of the pixels taken into account.

The H(x) is then estimated. In the estimation, the pixel where H(x) takes a value greater than a predetermined threshold value is a pixel containing many pieces of important information. Evaluation is applied only to the pixel talking such a value.

For the pixel value x exceeding the threshold value, the amplification rate is calculated by A (s,g) (x) with respect to the LUT determined as a gradient processing condition. If there is a pixel where A (s,g) and (xij) are smaller than predetermined values, modification is made in such a direction as to increase the parameter for determining the degree of equalization processing. The image to which equalization processing is applied is again evaluated in the same manner. This operation is repeated until there is no more pixel value equal to or smaller than the threshold value, or the conditional value of a predetermined parameter is reached. This procedure makes it possible to carry out adequate equalization processing.

(6-2-2) Frequency Enhancement Processing

Frequency enhancement processing is carried out by enhancing the high frequency component of the image. It improve the sharpness of the image. However, there has been a problem of deteriorating the granularity of the image if processing was carried out to a more than necessary level. To solve this problem, this frequency enhancement processing is applied in the following manner according to the weighted image. The enhancement correction factor calculated from the graph in FIG. 8 is multiplied by the factor representing the degree of enhancement in the frequency processing.

This arrangement allows the degree of enhancement in frequency processing to be reduced for each of the pixels less heavily weighted. A smaller degree of enhancement can be selectively assigned to noise or an unwanted area such as the area outside the irradiation field.

It is also possible to make such arrangements that a negative value is taken by a pixel of less importance, thereby allowing the pixel value to be reduced, as shown in FIG. 9.

(7) Display and Output

Based on the parameter determined by the parameter determining section 150 in the aforementioned manner, image processing is applied to image data by the image processing section 160, whereby processed image data is obtained.

If the aforementioned processed image data must be displayed on the image display section 160, it is displayed with one of the following items superimposed on the radiation image when the radiation image having been processed is displayed: These items are the degree of the geometrical shape contoured by the edge, the given weight, the adjustment indication value inputted from the operation input section 102, and the parameter obtained after having been determined by the parameter determining section 150. Here the image is preferably displayed with at least the parameter superimposed on the radiation image.

This arrangement clearly indicates what kind of edge has been detected, what kind of geometrical shape has been measured, what is the weight, and what parameter has been given to carry out image processing.

The following procedure can also be used: A plurality of weights are assigned in parallel, and image processing is carried out according to each of the parameters for a plurality of weights. The radiation images processed according to each of the parameters are displayed sequentially.

Correspondence among the edge, degree of the geometrical shape, weight and parameter is displayed together the radiation image having been processed. If there are multiple correspondences and radiation images having been processed, the radiation image having been processed and the correspondence among the edge, degree of the geometrical shape, weight and parameter may be displayed sequentially.

Upon completion of the aforementioned processing, the processed image data is outputted outside the apparatus through an interface or the like, based on the control of the control section 101.

(8) Parameter Adjustment

Image processing arranged in the aforementioned configuration can be adjusted according to the adjustment indication value from the operation input section 102. The parameter for determining the contents of image processing generally includes the coefficients of various functions and the weights of various elements, and the indicator thereof is not always easy to understand intuitively. Thus, when adjusting the contents of image processing, adequate adjustment cannot be made if the meaning is not understood.

Accordingly, to solve the problem, adjustment indication values that can be understood intuitively are prepared, and they are provided with a procedure for regulating the edge, degree of the geometrical shape, weight and parameter to be detected in the aforementioned processing. This arrangement can solve the aforementioned problem.

(8-1) Inputting the Adjustment Indication Value

The adjustment indication value for adjusting the parameter for image processing is preferably normalized at a value in the range from 0 through 9 wherever possible. This arrangement allows the adjustment personnel to clearly determine the position of the set value having been inputted within the permissible parameter range.

(8-1-a) Irradiation Field Shape

The adjustment indication value is set as the indication value predetermined based on the standard different from the parameter for image processing, with reference to the shape of irradiation field such as “1. circle”, “2. rectangle”, “3. hexagon” and “4. other polygon”. The shape of the graphic data to be detected by Hough Transform is modified in conformity to the preset indication value.

(8-1-b) Width of the Irradiation Field

The adjustment indication value is normalized at a value in the range from 0 through 9, and the value for the width of the irradiation field is preset as the adjustment indication value predetermined based on the standard different from that of the parameter for image processing.

(8-1-c) Importance of Image Center

The adjustment indication value is normalized at a value in the range from 0 through 9. For the importance of the degree of closeness to center of the image, the value at the image center is considered to be greater as the input value is greater. The pixel closer to the center is evaluated as more important (as having a greater weight).

(8-1-6d) Importance of Specific Area

The adjustment indication value is set as “1. right-hand corner of the screen”, “2. left-hand corner of the screen”, “3. top end corner of the screen”, “4. bottom end corner of the screen”, and “5. other area”. For the degree of importance of the screen-specific area, the degree of importance on the indicated side of the screen is set higher (a greater weight is assigned) according to the input value.

(8-1-e) Importance of High Frequency Component on Screen

The adjustment indication value is normalized at a value in the range from 0 through 9. As this value is greater, the degree of importance of the edge area obtained from the high resolution level of the 3-channel filter is set to a higher value as a whole.

(8-1-f) Importance of Reduction of Image Granularity

The adjustment indication value is normalized at a value in the range from 0 through 9. As this value is greater, the degree of enhancement of frequency processing is set at a lower value (a lower weight is assigned).

(8-1-g) Importance of the Difference Between Image Density and Indicated Density

The adjustment indication value is normalized at a value in the range from 0 through 9. The weight obtained from the image histogram output frequency is set at a higher value as a whole.

(8-1-h) Site Information

The adjustment indication value is normalized at a value in the range from 0 through 9. The degree of importance is changed according to the inputted numerical value denoting the site. For example, in the case of a small site such as a finger, the degree of the closeness to the center of the image is set in such a way that a higher weight is assigned at the position closer to the center. In the case of a large site as an abdomen, it is set in such a way that a weight is assigned uniformly over the entire image.

(8-2) Parameter Adjustment

Here the parameter for image processing is the one used for image processing by the image processing section 160. In the present embodiment, this parameter is different from the adjustment indication value inputted from the operation input section 102. Accordingly, arrangements are made in advance to ensure that the final parameter for image processing can be adjusted in conformity to the adjustment indication value.

Here the parameter for image processing refers to one or more than one parameter includes at least one of contrast adjustment parameter, gradient processing parameter, frequency processing parameter and equalization processing parameter.

The parameter for image processing generally includes the coefficients of functions and weights of various elements. The parameter is preferably adjusted based on the decision theory if adjustment is made from adjustment indication value to parameter. In the adjustment of parameter based on the decision theory from adjustment indication value to parameter, adjustment is more preferably made based on the fuzzy integration. Use of the fuzzy integration allows the adjustment to be made with consideration given to combinations in the case of adjustment from a plurality of adjustment indication values or adjustment to a plurality of parameters.

Even when the details of the image processing are not known, the aforementioned method of parameter adjustment allows image processing to be applied by the adequate parameter conforming to the actual image processing, merely by a simple input operation based on a subjective standard.

Each of the parameters adjusted according to the size of the adjustment indication value can be shaped in a linear form or in the form of a non-linear conversion table as shown in FIG. 10.

In the aforementioned example, the corresponding weight candidates were changed according to the adjustment indication value having been inputted. It is also possible to make such arrangements, for example, that the measure used in the fuzzy integration is changed for adjustment. In this case, if site information is available as the adjustment indication value input information, the fuzzy measure is adjusted in such a way that the measure of the set including the “degree of importance of the high-frequency component edge” is increased in the chest.

The aforementioned intuitively understandable adjustment indication values are prepared, and the adjustment procedure is provided for the edge, geometrical shape, weight and parameter detected in the aforementioned processing. Without being affected by the recognition failure resulting from deterministic recognition or recognition failure of unclear boundary, this arrangement ensures recognition of a structural image and determination of a weight free from recognition failure. Adequate image processing can be applied, despite the presence of an unclear boundary.

Disclosed embodiment can be varied by a skilled person without departing from the spirit and scope of the invention.

1. An image-processing method for applying an image processing to radiation image data, representing a radiation image acquired by projecting radial rays penetrated through a subject, so as to convert said radiation image to a processed radiation image suitable for a diagnosing purpose, said image-processing method comprising the steps of:
detecting an edge of a structural image contained in said radiation image;
measuring degree of a geometrical shape contoured by said edge detected in said detecting step;
determining a weight of said structural image, based on said degree of said geometrical shape measured in said measuring step; and
applying said image processing to said radiation image data, based on a parameter corresponding to said weight determined in said determining step.

2. The image-processing method of claim 1,
wherein at least one of a gradient processing and a frequency processing is applied in said applying step.

3. The image-processing method of claim 1,
wherein said geometrical shape includes a straight line and/or a circle determined in advance as a measuring object, and, with respect to said straight line and/or said circle, said degree of said geometrical shape contoured by said edge is measured in said measuring step.

4. The image-processing method of claim 1,
wherein a Hough Transform is employed for measuring said degree of said geometrical shape contoured by said edge in said measuring step, and, based on a vote number acquired by applying said Hough Transform to a measuring object, said degree of said geometrical shape is measured in said measuring step.

5. The image-processing method of claim 1,
wherein a filter processing is applied to said radiation image data in said detecting step to detect said edge of said structural image contained in said radiation image; and
wherein said filter processing includes at least one of a Laplacian filtering operation, a differential filtering operation, a multi-resolution analyzing operation, a Wavelet transforming operation and a three-channel filter bank operation.

6. The image-processing method of claim 5,
wherein a Sobel filtering operation is employed as said differential filtering operation to detect said edge of said structural image contained in said radiation image.

7. The image-processing method of claim 5,
wherein a combination of an averaging filter, a Laplacian filter and a Sobel filter is employed for said three-channel filter bank operation in said detecting step.

8. The image-processing method of claim 1,
wherein the greater said degree of said geometrical shape, measured in said measuring step with respect to a processing object, is, the more said weight to be determined is increased.

9. The image-processing method of claim 1,
wherein the greater said degree of said geometrical shape, measured in said measuring step with respect to a processing-excluded object, is, the more said weight to be determined is decreased.

10. The image-processing method of claim 1,
wherein said weight is determined for every pixel, included in said radiation image data, in said determining step.

11. The image-processing method of claim 1,
wherein, based on a function determined in advance, said weight is determined in said determining step.

12. The image-processing method of claim 11,
wherein a primary combined function combined with an edge strength is employed as said function in said determining step.

13. The image-processing method of claim 1,
wherein said weight is determined in said determining step, based on relationship between a plurality of degrees of geometrical shapes, each corresponding to said degree of said geometrical shape, measured by said geometrical shape measuring section.

14. The image-processing method of claim 13,
wherein, when said plurality of degrees of geometrical shapes indicate straight lines, said relationship between said plurality of degrees of geometrical shapes is determined, based on a fact that said straight lines, having substantially a same degree of geometrical shape, reside at constant intervals.

15. An image-processing apparatus for applying an image processing to radiation image data, representing a radiation image acquired by projecting radial rays penetrated through a subject, so as to convert said radiation image to a processed radiation image suitable for a diagnosing purpose, said image-processing apparatus comprising:
an edge detecting section to detect an edge of a structural image contained in said radiation image;
a geometrical shape measuring section to measure degree of a geometrical shape contoured by said edge detected by said edge detecting section;
a weight determining section to determine a weight of said structural image, based on said degree of said geometrical shape measured by said geometrical shape measuring section; and
an image-processing section to apply said image processing to said radiation image data, based on a parameter corresponding to said weight determined by said weight determining section.

16. The image-processing apparatus of claim 15,
wherein said image-processing section includes at least one of a gradient processing section for applying a gradient processing and a frequency processing section for applying a frequency processing.

17. The image-processing apparatus of claim 15,
wherein said geometrical shape includes a straight line or a circle determined in advance as a measuring object, and said geometrical shape measuring section measures said degree of said geometrical shape contoured by said edge with respect to said straight line or said circle.

18. The image-processing apparatus of claim 15,
wherein said geometrical shape measuring section employs a Hough Transform to measure said degree of said geometrical shape contoured by said edge, and measures said degree of said geometrical shape, based on a vote number acquired by applying said Hough Transform to a measuring object.

19. The image-processing apparatus of claim 15,
wherein said edge detecting section applies a filter processing to said radiation image data to detect said edge of said structural image contained in said radiation image; and
wherein said filter processing includes at least one of a Laplacian filtering operation, a differential filtering operation, a multi-resolution analyzing operation, a Wavelet transforming operation and a three-channel filter bank operation.

20. The image-processing apparatus of claim 19,
wherein said edge detecting section employs a Sobel filtering operation as said differential filtering operation to detect said edge of said structural image contained in said radiation image.

21. The image-processing apparatus of claim 19,
wherein said edge detecting section employs a combination of a simple average filter, a Laplacian filter and a Sobel filter for said three-channel filter bank operation.

22. The image-processing apparatus of claim 15,
wherein the greater said degree of said geometrical shape, which is measured by said geometrical shape measuring section with respect to a processing object, is, the more said weight determining section increases said weight to be determined.

23. The image-processing apparatus of claim 15,
wherein the greater said degree of said geometrical shape, which is measured by said geometrical shape measuring section with respect to a processing-excluded object, is, the more said weight determining section decreases said weight to be determined.

24. The image-processing apparatus of claim 15,
wherein said weight determining section determines said weight for every pixel included in said radiation image data.

25. The image-processing apparatus of claim 15,
wherein said weight determining section determines said weight, based on a function determined in advance.

26. The image-processing apparatus of claim 25,
wherein said weight determining section employs a primary combined function combined with an edge strength as said function.

27. The image-processing apparatus of claim 15,
wherein said weight determining section determines said weight, based on relationship between a plurality of degrees of geometrical shapes, each corresponding to said degree of said geometrical shape, measured by said geometrical shape measuring section.

28. The image-processing apparatus of claim 27,
wherein, when said plurality of degrees of geometrical shapes indicate straight lines, said relationship between them is determined, based on a fact that said straight lines, having substantially a same degree of geometrical shape, reside at constant intervals.

29. A program for executing an image-processing operation for applying an image processing to radiation image data, representing a radiation image acquired by projecting radial rays penetrated through a subject, so as to convert said radiation image to a processed radiation image suitable for a diagnosing purpose, said program comprising the functional steps of:
detecting an edge of a structural image contained in said radiation image;
measuring degree of a geometrical shape contoured by said edge detected in said detecting step;
determining a weight of said structural image, based on said degree of said geometrical shape measured in said measuring step; and
applying said image processing to said radiation image data, based on a parameter corresponding to said weight determined in said determining step;
wherein at least one of a gradient processing and a frequency processing is applied in said applying step.
